(19) United States
(12) Patent Application Publication
(10) Pub. No.: US 2015/0106146 A1
(43) Pub. Date: Apr. 16, 2015

(54) PRIORITY CALENDAR

(71) Applicants: Kristin HIGAKI, Mountain View, CA (US); Nabil Shahid, Mountain View, CA (US)

(72) Inventors: Kristin HIGAKI, Mountain View, CA (US); Nabil Shahid, Mountain View, CA (US)

(73) Assignee: GOOGLE INC., Mountain View, CA (US)

(21) Appl. No.: 13/526,389

(22) Filed: Jun. 18, 2012

(51) Int. Cl. G06Q 10/10

(52) U.S. Cl. CPC G06Q 10/1095
USPC 705/7.19

(57) ABSTRACT

A computer-implemented method for creating an electronic meeting event is provided. The method includes receiving event information for a meeting event from a user, determining external signals related to the received event information and providing for transmitting to the user, a first electronic suggestion to add meeting participants to the meeting event, wherein the first electronic suggestion is based at least on one of received event information for the meeting event or the determined external signals related to the received event information. The method also includes receiving a user response to the first electronic suggestion to add meeting participants to the meeting event and providing for transmitting to the user, a second electronic suggestion to add additional meeting participants to the meeting event, wherein the second electronic suggestion is based on at least the received user response to the first generated electronic suggestion.

### FIELD

The subject disclosure relates generally to improving calendar applications, and, in particular, to suggesting participants for meeting events.

### BACKGROUND

Calendaring applications are widely used by organizations to create meeting events. A meeting request may be created that causes a calendar invitation to be sent to one or more meeting participants identified by the event organizer People, whether within an organization or not, may create several meeting events each day, and dozens of such meeting events weekly. It may become difficult to keep track of all of the participants who should be invited to all of the different meetings. Lists may be used to create meeting events, however, such lists may need to constantly be manually maintained to keep current.

### SUMMARY

The subject disclosure relates to a machine-implemented method for creating an electronic meeting event. The method includes receiving event information for a meeting event from a client device associated with a user, determining external signals related to the received event information and providing for transmitting to the client device, a first electronic suggestion to add meeting participants to the meeting event, wherein the first electronic suggestion is based at least on one of received event information for the meeting event or the determined external signals related to the received event information. The method also includes receiving a response to the first electronic suggestion to add meeting participants to the meeting event and providing for transmitting to the client device, a second electronic suggestion to add additional meeting participants to the meeting event, wherein the second electronic suggestion is based on at least the received response to the first generated electronic suggestion.

According to another aspect, the disclosed subject matter relates to a system for creating an electronic meeting event. The system includes one or more processors and a machine-readable medium comprising instructions stored therein, which when executed by the processors, cause the processors to perform certain operations. The operations include receiving an indication of event information for a meeting event from a client device, identifying a meeting participant based on at least one of the received event information for the meeting event or external signals related to the event information and generating a first electronic suggestion to add the identified meeting participant to the meeting event. The operations also include providing for transmitting to the client device the first generated electronic suggestion to add the identified meeting participant, receiving an indication of response to the first provided electronic suggestion to add the identified meeting participant, identifying an additional meeting participant based on the received indication of response to the first provided electronic suggestion, generating a second electronic suggestion to add the additional meeting participant and providing for transmitting to the client device, the second generated electronic suggestion to add the additional meeting participant to the meeting event.

In another aspect, the disclosed subject matter relates to a machine-readable medium comprising instructions stored therein, which when executed by the processors, cause the processors to perform certain operations. The operations include receiving event information for a meeting event, determining external signals related to the received event information and generating a first electronic suggestion to add meeting participants to the meeting event. Generating the first electronic suggestion includes identifying meeting participants based at least on one of received event information for the meeting event or the determined external signals related to the received event information. The operations further also include receiving a response to the first generated electronic suggestion to add meeting participants to the meeting event and generating a second electronic suggestion to add additional meeting participants to the meeting event, wherein generating the second electronic suggestion includes identifying additional meeting participants based on at least the received response to the first generated electronic suggestion.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 is a diagram of an example system for creating an electronic meeting event.

FIG. 2 illustrates a flow diagram of an example process for creating a meeting event.

FIG. 3 conceptually illustrates an example interface of a meeting event according to an aspect of the subject technology.

FIG. 4 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed technology provides a solution that makes it easier for a meeting event organizer to make sure all participants who should be invited to a meeting event are invited. The disclosed subject matter provides for suggesting meeting participants based on meeting event information entered by a user at a client device at the time the user creates the meeting event, as well as on external signals associated with the meeting event information entered by the user at the client device. The minimum meeting event information that is entered includes at least one of a meeting event participant, a meeting name or a location for the meeting event.

The external signals related to the event information include, but are not limited to, organizational charts, meeting history, indirect meeting history, mailing lists, social network associations, or other meeting details. For example, an organizational chart may provide names of people on the same team as the user, the meeting event participant, if provided, or the user's manager. Meeting history may provide names of participants the user invited to other meetings or who have been on the same invite for another meeting event as the user. Indirect meeting history may provide names of participants that meet regularly with a participant whom the user included in the meeting event request, for example.

External signals may also include signals related to the meeting event organizer's responses to previous electronic suggestions made by the system for previous meeting events. For example, if a participant was suggested to the meeting event organizer for an out of town meeting but the organizer rejected the electronic suggestion, that participant will not be suggested to the meeting event organizer for another out of town meeting, because of the organizer's prior response. External signals may also be weighted according to priority or rank. Thus, based on meeting event information, some external signals may be more important than others. For example, for an out of town meeting, external signals related to location may be deemed more important than external signals related to organizational structure.

When the minimum required meeting event information is received, a meeting participant is identified by the system based on at least one of the event information received from the client device associated with the user or the external signals related to the information received from the client device associated with the user. An electronic suggestion to add the identified meeting participant to the meeting event is then generated by the system and transmitted to the client device associated with the user. The user responds to the electronic suggestion at the client device by selecting or rejecting one or more of the suggested participants. Based on the user's response to the first provided electronic suggestion, a second electronic suggestion is generated by the system and transmitted to the client device associated with the user. The user's response to the first provided electronic suggestion is used as an additional signal for identifying additional meeting participants and generating the second electronic suggestion. Event information received from the user scheduling the meeting event and external signals related to the event information may additionally be used by the system for determining a priority rank of the meeting event. The priority rank may also be used in identifying meeting participants.

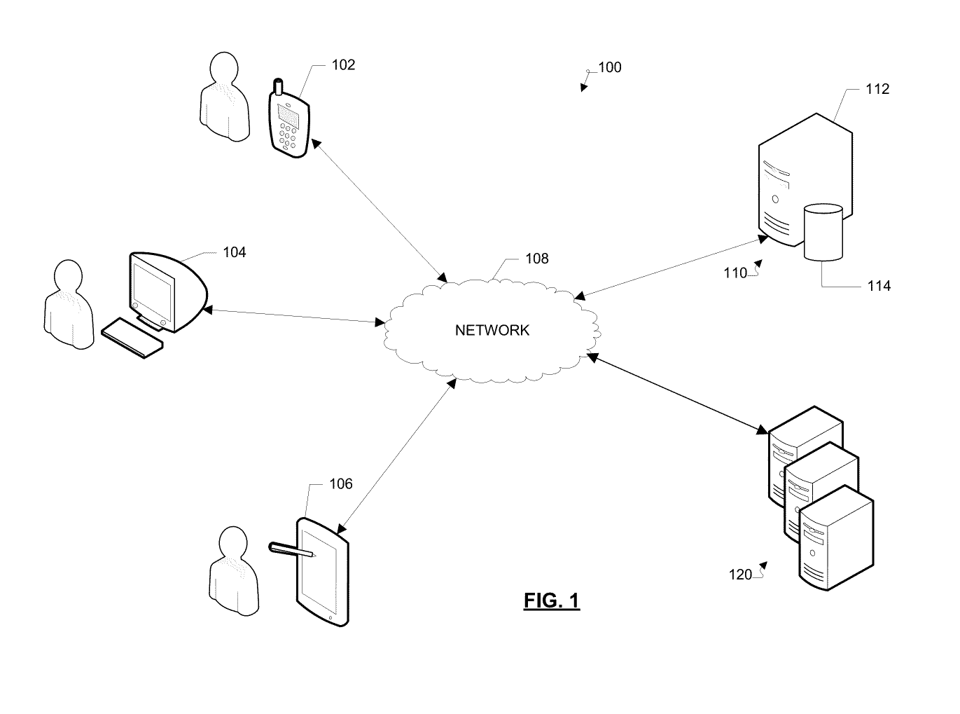

FIG. 1 illustrates an example client-server network environment which provides for creating an electronic meeting event. A network environment 100 includes a number of electronic devices 102, 104 and 106 communicably connected to a server 110 by a network 108. Server 110 includes a processing device 112 and a data store 114. Processing device 112 executes computer instructions stored in data store 114, for example, to create an electronic meeting event. Data store 114 may store information from which external signals may be identified. For example, data store 114 may store organizational charts, responses to previous electronic suggestions, meeting histories, mailing lists and social network associations.

Processing device 112 may further identify meting participants for suggesting to a user, determine external signals, generate a electronic suggestion and cause the electronic suggestion to be transmitted to a client device associated with a user. Processing device 112 may also identify, based on the user's response to a provided electronic suggestion, additional meeting event participants that should be suggested to the user.

Servers 120 may host a calendaring application within which some of the processes discussed herein are implemented. In some example aspects, electronic devices or client devices, as used interchangeably herein, 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In the example of FIG. 1, electronic device 102 is depicted as a smartphone, electronic device 104 is depicted as a desktop computer, and electronic device 106 is depicted as a PDA. A client in an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

The system (e.g., hosted at server 110) detects a meeting event being created or a request to create a meeting event at a client device (e.g., electronic devices 102, 104 or 106). Upon detecting a meeting event being created or requested, the system, identifies event information that is entered by a user at a client device associated with the user, creating the meeting event, and based on the received event information, identifies external signals related to the received event information.

The external signals include, but are not limited to, organizational charts, meeting history, indirect meeting history, mailing lists, social network associations, the meeting event's priority rank, or other meeting details. The external signals may be determined based on information stored in a data store 114, for example, and used by the server 110 when identifying meeting participants. Meeting participants may, therefore, be identified based on the received event information, external signals, or a combination thereof. The identified meeting participants are provided to the user in an electronic suggestion that is transmitted to a client device associated with the user.

Server 110 or servers 120 may also receive the user's response to the provided electronic suggestion via the client device, and identify additional meeting participants based on the response. The additional meeting participants are provided to the user in a second electronic suggestion.

In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

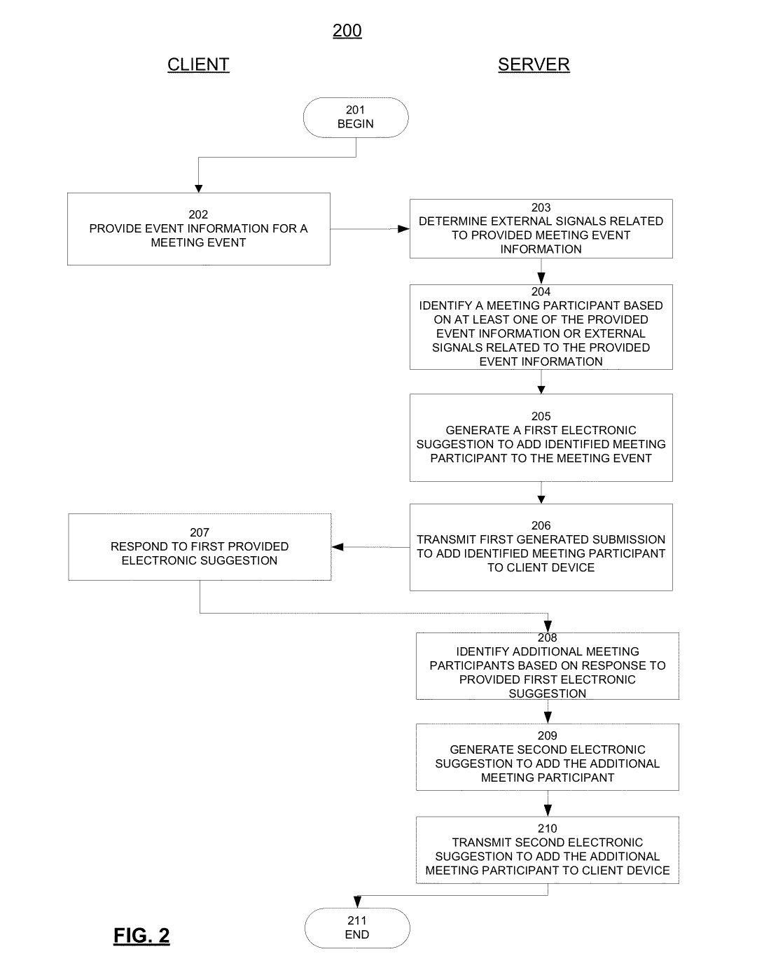

FIG. 2 illustrates an example process 200 for creating an electronic meeting event using the example client 110 and server 110. The process 200 begins by proceeding from step 201 when a calendaring application is engaged by a user at a client device associated with the user. At step 202, event information for a meeting event is provided by the user to the system via a client device associated with the user. The meeting event may be a new event or it may be a pre-existing event. The minimum event information that is required may be at least one of a meeting event participant, a meeting name, or a location for the meeting event. The meeting event participant may be identified by a name, an alias, an email address or a social network nickname, for example. Participants may also be identified by referring to a group name or an email list.

A meeting name may reference, for example, any new or on-going project, task or assignment at an organization, a social network topic, or any other reference to a meeting event or task. For example, a meeting name may be “team outing,” “weekly budget planning” or “monthly manager meeting.” Location information may include, but is not limited to, an address, a building name, or an office location.

At step 203, external signals related to the provided event information are determined by the system. The external signals related to the event information include, but are not limited to, organizational charts, meeting history, indirect meeting history, mailing lists, social network associations, responses to previous electronic suggestions, or other meeting details.

For example, an organizational chart may provide names of people on the same team as the user, or a an invited participant, if provided. The organizational chart may also provide the name of the user's manager or a list of common managers who are associated with the user or the manager. Meeting history may provide names of participants the user has invited to other meetings or who have been on the same invitation for another meeting event as the user. Indirect meeting history may provide names of participants who, for example, meet regularly with a participant whom the user included in the meeting event. Social network associations may provide names of participants who are associated with an invited participant. Other meeting details may include the meeting event's description, date or occurrence frequency.

To that end, key words may be identified in the meeting description and cross-referenced with meeting event names that others have created in the past to find relevance. Meeting location may also be relevant. The system may look through the user's or the participants' contacts to find addresses of potential participants who live or work near the meeting location and suggest those potential participants.

According to an aspect of the disclosed subject matter, external signals may be weighted in the system. Thus, some external signals may be given a greater priority than others. For example, responses to previous electronic suggestions may have greater weight than other external signals. Alternatively, location information may be treated as a stronger signal when meeting events are scheduled away from the usual home or work address of the user or the participants. When, for example, a Los Angeles, CA based user creates a meeting event called “Vacation” in “Hawaii” as the location, the location information may serve as a dominant external signal, since it would make more sense to suggest participants in or near “Hawaii” than from the user's home city when the user is on vacation in Hawaii.

At step 204, meeting participants are identified by the system. The meeting participants are identified based on at least one of the provided event information or determined external signals related to the provided event information. For example, User A works on the same team with co-workers B, C, and D, who is a manager. The team also includes co-workers E, F, and G, who is also a manager. The “ABCD” team may be involved on a project titled “Quarterly Budget,” while the “DEFG” team is involved on a different project. When user A creates a meeting event called “Team Outing,” the system will identify co-workers B, C and D as potential meeting participants whom User A should include on the “Team Outing” event because co-workers B, C, and D are also on User A's team. As User A continues to provide additional event information, meeting participants may continue to be identified. Thus, if User A also adds co-worker B as a participant, only co-workers C and D are identified by the system as participants whom User A should include on the “Team Outing” event.

At step 205, the system generates a first electronic suggestion for User A to add the identified meeting participants B, C and D to the meeting event. The system transmits the first generated electronic suggestion or causes it to be transmitted to the client device associated with the user at step 206. The electronic suggestion may be presented to User A as a frame or another GUI element in the meeting event window. There may be a “Suggested Participants” filed in which the suggested participants may be listed along with a response field, where User A may respond to the electronic suggestion by accepting or rejecting the suggested participants presented in the electronic suggestion.

At step 207, User A responds, via the client device associated with the user, to the first provided electronic suggestion and the response is received in the system. The user may select to accept or reject one or more of the suggested participants B, C, and D. According to an aspect of the disclosed subject matter, when a suggested participant is rejected, the system interprets the rejection as a signal that the electronic suggestion was bad. The system may then lower the importance of the factors that caused the rejected participant to be suggested to the user. When the user accepts a suggested participant, the system treats the acceptance as a signal that the electronic suggestion was good and increases the importance of the factors that caused that electronic suggestion to be made.

Based on the user's response to the first electronic suggestion, the system identifies additional meeting participants at step 208. If, for example, User A added suggested participants B and C, but not participant D, the system may treat this response as a signal that participant D, the manager, in not involved in this meeting. The system may then suggest other people on A's team, but not the managers. Thus, the system may suggest co-workers E and F, but not co-workers D and G. The system will have learned, from User A's response, that managers are not invited and suggests other participants who are not managers.

In another example, if user A works with co-worker B on “books,” with co-worker C on “advertising” and with co-worker D on “budgets,” and creates a meeting called “weekly meeting,” all of co-workers B, C, and D may be suggested to user A in a first electronic suggestion, because “weekly meeting” is generic enough to apply to all of the projects that user A is working on with co-workers B, C and D. If user A selects only co-worker B because the meeting is about books, the second electronic suggestion with a refreshed list of additional participants will no longer include co-workers C and D. The second electronic suggestion may, however, include co-workers E and F, if co-workers E and F also work on the “books” project. The system may also suggest other additional participants, if user A has met with them in the past on meetings about the “books” project.

At step 209, a second electronic suggestion to add the to the meeting event the additional meeting participants identified at step 208 is generated for User A and transmitted to a client device associated with User A at step 210. Process 200 ends at step 211.

While a meeting event organizer's response at step 207 is used by the system for the same meeting event, the response may additionally used by the system for suggestion participants for future meeting events created by the organizer For example, User A schedules a meeting event called “Dinner” with participants N and B. User A also schedules a meeting event called “Coffee” and invites participant D. According to the mechanisms disclosed herein, participant B is suggested to User A, because User A previously invited participant B for dinner with User A and participant N. When participant B schedules a meeting event called “Coffee” and invites participant K, the system may suggest that participant N be added to the meeting event. If Participant B rejects the electronic suggestion to add participant N, then participant N will not be suggested to participant B on his future invitations to participant K for coffee because participant N was previously rejected. Thus, the organizer's response to a electronic suggestion may be used when generating a electronic suggestion to add a meeting participant in subsequent meeting events.

In another example a first meeting may be scheduled by User A in Los Angeles, Ca., which is the home office, with participant B included on the meeting. Based on the event information entered by User A for the first meeting, such as location or meeting name, participants C, D, and E may be suggested. However, User A adds only participants C and D. Then, User A schedules a second meeting with participant B in San Francisco, Calif. (off-site), and participants C and D, are suggested, but not participant E, because he was previously rejected. Still, however, neither participant C nor participant D is accepted by User A. When User A schedules a third meeting with Participant B in San Diego, also off-site, participants F, G, and H will be suggested, but not participants C, D or E, because they were not accepted by User A for a meeting away from the Los Angeles home office, and thus should not be suggested for an off-site meeting in San Diego.

In yet another example, User A schedules a meeting with participant B about “books.” The system may suggest participant C, because C often meets with participant B in meetings including the term “books.” If User A rejects participant C, then when User A schedules another meeting with participant B about “books,” participant C will not be suggested to User A.

In a further example, if User A schedules a meeting with participants B, F, and G, of whom participants B and F are associated with each other at a social network, and participant G is associated with participant F, but not with participant B. When User A schedules another meeting with participant F, participants G and I may be suggested, if participant I is associated with participants G and F at the social network.

As discussed above, User A's responses to electronic suggestions may be stored in the system and used as a learning tool to improve the electronic suggestion quality of future electronic suggestions. Responses to previously made electronic suggestions may be part of the external signals used by the system when identifying meeting participants for a meeting event.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

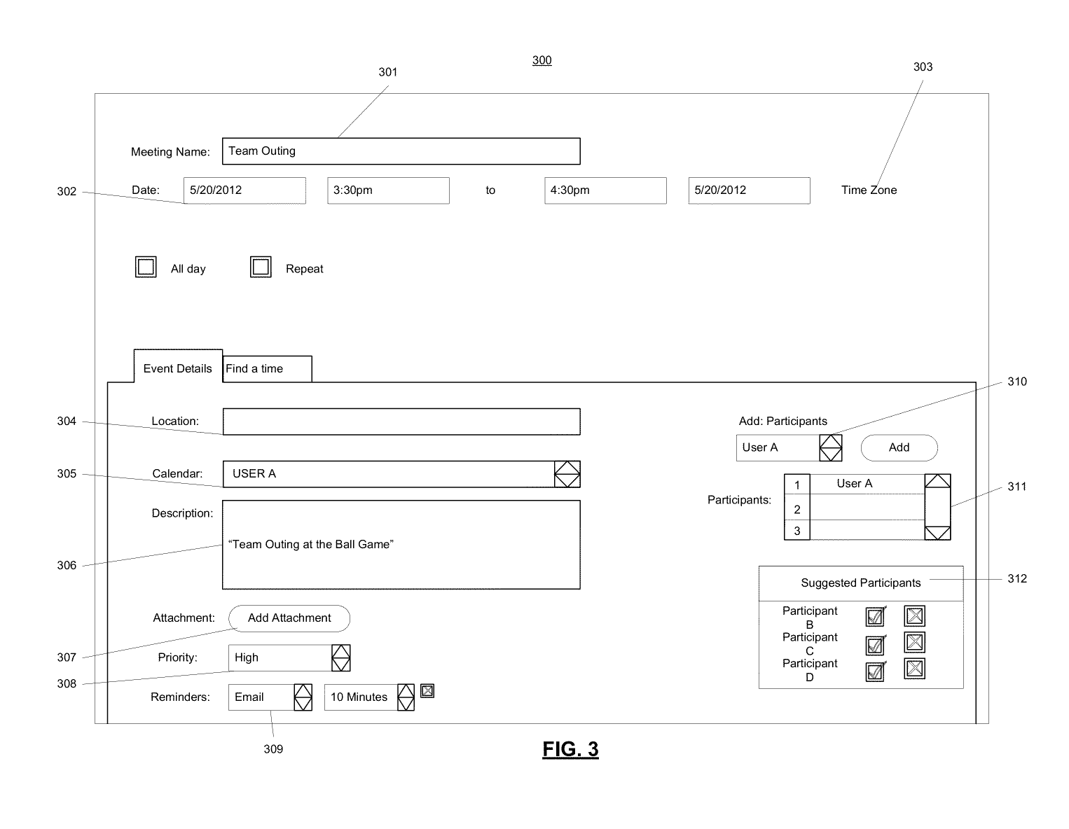

FIG. 3 illustrates an example meeting event 300, according to example aspects. Meeting event 300 includes a meeting name field 301. The meeting name may be supplied by the meeting event organizer, for example User A. User A may be identified in Calendar ID field 305, which corresponds to the user whose calendar is shown. Location field 304 designates a location for the meeting event 300. The location may be an address, a location nick-name, a city code, an office number or another location identifier. Participant field 311, if filled in by User A, designates the participants invited by the meeting event organizer, User A. According to an aspect of the disclosed subject matter, the minimum information that is required for suggesting meeting participants is at least one or more of: Meeting Name 301, Location field 304 or Participant field 311.

Participants may be selected and/or added through field 310. Several other fields, such as the Date field 302, Time zone field 303, Calendar ID field 305, Description field 306, Attachment field 307, Priority field 308, and Reminder field 309 may also be filled out for meeting event 300. Some fields may be filled in by the user in free-form text, while others may be searchable and selectable. Priority field 308 may be filled in by the user or the system, depending on implementation. Priority of a meeting event may be based on the event information provided by the user, the external signals, or a combination thereof

Suggested participants field 312 is populated by the system when the system provides an electronic suggestion for the user to add the identified meeting participants to the meeting event. This field may be a frame or a pop-up GUI that contains the meeting participants listed in such a electronic suggestion, which is provided to User A by the system. Suggested participants field may be refreshed continuously, as the user adds or changes meeting event information. When a first electronic suggestion is provided, as described at step 206 of the process 200 described above, the user may respond to the electronic suggestion in the Suggested Participant field 312 by accepting or rejecting a suggested participant. Based on the user's response, the Suggested Participants field 312 is refreshed. Step 209 of the process 200 describes how the Suggested Participants field 312 may be refreshed when additional participants are suggested in response to the user's response to the first electronic suggestion provided in step 206 of process 200. To that end, the system identifies additional meeting participants based on the user response to the first provided electronic suggestion. The system them provides the additional meeting participants in the second electronic suggestion.

Systems may set limits for how many times the Suggested Participants field 312 is refreshed. For example, it may be implemented that, for example, only 3 or 4 cycles are permitted. Alternatively, it may be implemented that a user may receive unlimited electronic suggestions. Still further, it may be implemented that a user may accept a provided electronic suggestion any time by saving the event, but without explicitly accepting a suggested meeting participant.

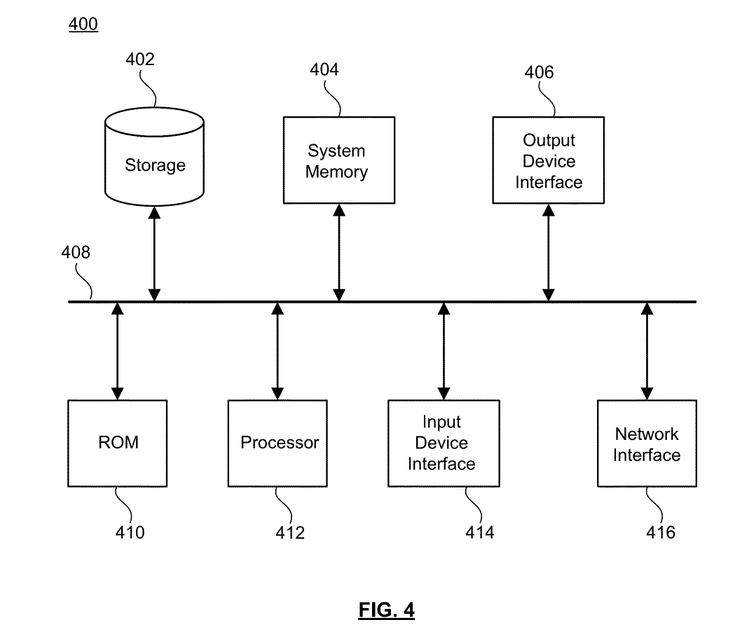

FIG. 4 conceptually illustrates an electronic system with which some aspects of the subject technology are implemented. Electronic system 400 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. For example, the various memory units include instructions for processing electronic meeting events associated with an application according to various embodiments. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for creating an electronic meeting event, the method comprising:
receiving, using one or more processors, event information for a meeting event from a client device associated with a user, the event information including a meeting location for the meeting event;
determining, using the one or more processors, external signals related to the received event information, wherein an external signal associated with location information is assigned greater weight than other external signals when the meeting location is different from a regular location of the user;
providing for transmitting to the client device, using the one or more processors, a first electronic suggestion to add meeting participants to the meeting event, wherein the first electronic suggestion is based at least on one of received event information for the meeting event or the determined external signals related to the received event information, wherein suggested meeting participants include those located in proximity to the meeting location;
receiving, using the one or more processors, a response from the client device associated with the user, to the first electronic suggestion to add meeting participants to the meeting event;
determining, using the one or more processors, differences between the suggested meeting participants who were and were not added by the response from the client device; and
providing for transmitting to the client device, using the one or more processors, a second electronic suggestion to add additional meeting participants to the meeting event, wherein the second electronic suggestion is based on at least the received response from the client device associated with the user, to the first generated electronic suggestion.

2. The computer-implemented method of claim 1, wherein providing for transmitting to the client device, using the one or more processors, the first electronic suggestion includes identifying, using the one or more processors, meeting participants based at least on one of received event information for the meeting event or the determined external signals related to the received event information.

3. The computer-implemented method of claim 1, wherein providing for transmitting to the client device, using the one or more processors, the second electronic suggestion includes identifying, using the one or more processors, additional meeting participants based on one or more of the received response to the first electronic suggestion, received event information for the meeting event or external signals related to the received event information.

4. The computer implemented method of claim 1, further comprising:
determining, using the one or more processors, a priority rank for the meeting event based on the received event information.

5. The computer implemented method of claim 4, wherein identifying, using the one or more processors, the meeting participants includes identifying the meeting participants based at least in part on at least one of the event information or the determined priority rank of the meeting event.

6. The computer implemented method of claim 1, wherein the external signals related to the event information correspond to at least one of an organization chart, a meeting history, an indirect meeting history, a mailing list or a social network referenced by the event information, or one or more responses to previous electronic suggestions.

7. The computer-implemented method of claim 1, wherein receiving, using the one or more processors, the response from the client device associated with the user to the first electronic suggestion to add meeting participants to the meeting event further comprises:
storing, using the one or more processors, the received response to the first electronic suggestion in a data store, for use as an external signal for subsequent meeting events.

8. The computer-implemented method of claim 7, wherein the external signal based on the received response to the first electronic suggestion has a greater weight than the external signals related to the received event information when identifying meeting participants or additional meeting participants.

9. The computer-implemented method of claim 1, wherein external signals related to the received event information are weighted.

10. The computer-implemented method of claim 1, wherein the received event information further includes at least one of a meeting event participant or a meeting name for the meeting event.

11. A system for creating an electronic meeting event, the system comprising:
one or more processors; and
a machine-readable medium comprising instructions stored therein, which when executed by the processors, cause the processors to perform operations comprising:
receiving an indication of event information for a meeting event from a client
device associated with a user, the event information including a meeting location for the meeting event;
identifying a meeting participant based on at least one of the received event
information or external signals related to the event information, wherein the identified meeting participant is located in proximity to the meeting location, wherein an external signal associated with location information is assigned greater weight than other external signals when the meeting location is different from a regular location of the user;
generating a first electronic suggestion to add the identified meeting participant to the meeting event;
providing for transmitting to the client device associated with the user, the first generated electronic suggestion to add the identified meeting participant;
receiving, from the client device associated with the user, an indication of response to the first provided electronic suggestion to add the identified meeting participant;
determining a reason the identified meeting participant was or was not added;
identifying an additional meeting participant based on the determined reason;
generating a second electronic suggestion to add the additional meeting participant; and
providing for transmitting to the client device associated with the user, the second generated electronic suggestion to add the additional meeting participant to the meeting event.

12. The system of claim 11, the operations further comprising:
determining a priority rank for the meeting event based on the event information.

13. The system of claim 12, wherein the meeting participant is identified based at least in part on at least one of the event information or the determined priority rank of the meeting event.

14. The system of claim 11, wherein the external signals related to the event information correspond to at least one of an organization chart, a meeting history, an indirect meeting history, a mailing list or a social network referenced by the event information.

15. The system of claim 11, wherein the one or more additional meeting participants are different from the one or more meeting participants.

16. The system of claim 11, wherein the received event information further includes at least one of a meeting event participant or a meeting name for the meeting event.

17. The system of claim 11, wherein the external signals related to the event information include signals associated with one or more responses to electronic suggestions provided in other meeting events.

18. A non-transitory machine-readable medium comprising instructions stored therein, which when executed by the processors, cause the processors to perform operations comprising:
receiving, from a client device associated with a user, event information for a meeting event, the event information including a meeting location for the meeting event;
determining external signals related to the received event information, wherein an external signal associated with location information is assigned greater weight than other external signals when the meeting location is different from a regular location of the user;
generating a first electronic suggestion to add meeting participants to the meeting event, wherein generating the first electronic suggestion includes identifying meeting participants based at least on one of received event information for the meeting event or the determined external signals related to the received event information, wherein suggested meeting participants include those located in proximity to the meeting location;
receiving, from the client device associated with the user, a response to the first generated electronic suggestion to add meeting participants to the meeting event;
determining differences between the suggested meeting participants who were and were not added by the response from the client device; and
generating a second electronic suggestion to add additional meeting participants to the meeting event, wherein generating the second electronic suggestion includes identifying additional meeting participants based on at least the received response from client device associated with the user, to the first generated electronic suggestion.

19. The non-transitory machine-readable medium of claim 18, wherein the external signals related to the event information correspond to at least one of an organization chart, a meeting history, an indirect meeting history, a mailing list or a social network referenced by the event information.

20. (canceled)
